(19) United States
(12) Patent Application Publication
(10) Pub. No.: US 2016/0021586 A1
(43) Pub. Date: Jan. 21, 2016

(54) CHANNEL CONGESTION MITIGATION

(71) Applicant: Facebook, Inc., Menlo Park, CA (US)

(72) Inventors: Fraidun Akhi, Fremont, CA (US); Yael Maguire, Boston, MA (US)

(21) Appl. No.: 14/333,353

(22) Filed: Jul. 16, 2014

(51) Int. Cl. H04W 36/06; H04W 28/02

(52) U.S. Cl. CPC H04W 36/06; H04W 28/0289; H04W 36/165

(57) ABSTRACT

Various embodiments implement protocols and algorithms for selectively transitioning peers in a P2P group, e.g., less than all the peers in the group, from a first channel to a second channel. The group owner may consider: which peers are in communication; the quality of an existing channel link with the peers; and the quality of an alternative channel. The alternative channel may have been identified actively or passively during the search and scan processes used to establish the group. When a transition is to occur, a modified channel switch announcement message identifying individual MAC addresses for transition may be used to effect the transition. Measurement of the peer-to-peer link quality may be accomplished using standard 802.11 measurement request primitives.

### TECHNICAL FIELD

The disclosed embodiments relate to channel assignments among the members of one or more peer-to-peer (P2P) groups, e.g., in a Wi-Fi Direct arrangement.

### BACKGROUND

The increasing ubiquity of personal wireless devices has generated increasing pressure to use scarce bandwidth resources efficiently. For example, the Wi-Fi™ Display and Wi-Fi™ Direct standards permit devices to be arranged in a Peer-to-Peer (P2P) group so as to effectively coordinate their transmissions. One member of the P2P group, designated the “group owner”, may coordinate communications among the other “peer” or “client” devices of the group. Unfortunately, not all the members of the group may have the same or similar resource demands. For example, one device may be involved in a data intensive Voice Over IP (VOIP) transaction or Wi-Fi™ Display video stream, while another device may perform only periodic webpage refreshes. The changing channel quality in different environments, at different times, and in different frequencies, further complicates the situation. While the P2P group owner may wish to reallocate channel resources to accommodate the bandwidth intensive devices, an efficient method under the P2P standard for doing so may not be available.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1 is a block diagram showing a channel reassignment process as disclosed in some embodiments where the reassigned clients remain within the original group.

FIG. 2 is a block diagram depicting a channel reassignment process as disclosed in some embodiments where the reassigned clients enter a new group.

FIG. 3 is a timeline diagram showing channel assessment steps in the scan and search phases of P2P device discovery as disclosed in some embodiments.

FIG. 4 illustrates a modified channel switch announcement message as may be used in some embodiments.

FIG. 5 is a flow diagram showing various operations in a channel reassignment process as may occur in some embodiments.

FIG. 6 is a block diagram of a computer system as may be used to implement features of some of the embodiments.

While the flow and sequence diagrams presented herein show an organization designed to make them more comprehensible by a human reader, those skilled in the art will appreciate that actual data structures used to store this information may differ from what is shown, in that they, for example, may be organized in a different manner; may contain more or less information than shown; may be compressed and/or encrypted; etc.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments as defined by the appended claims.

### DETAILED DESCRIPTION

Various examples of the disclosed techniques will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this section.

Overview—Channel Reassignment with Group Retention

Various embodiments include protocols and algorithms for selectively transitioning peers in a P2P group, e.g., less than all the peers in the group, from a first channel to a second channel. The group owner may consider: which peers are in communication; the quality of an existing channel link with the peers; and the quality of an alternative channel. The alternative channel may have been identified actively or passively during the search and scan processes used to establish the group. When a transition is to occur, a modified channel switch announcement message identifying individual MAC addresses for transition may be used to effect the transition. Measurement of the peer-to-peer link quality may be accomplished using standard 802.11 measurement request primitives.

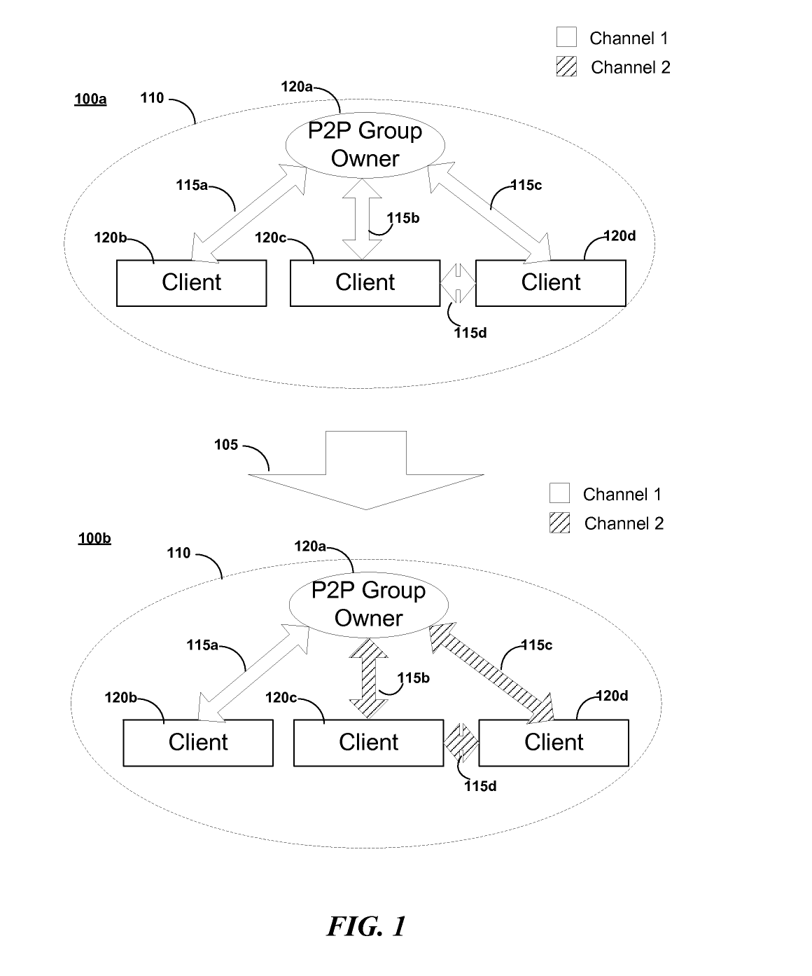

FIG. 1 is a block diagram showing a channel reassignment process as implemented in some embodiments where the reassigned clients remain within the original P2P group. In a first configuration 100a, an initial P2P group 110 may include four devices organized as a group owner 120a, and a plurality of client/peer devices 120b-d. The client devices 120b-d may be in communication with the group owner 120a via a plurality of connections 115a-c on a first channel. Connections 115a-c may not reflect isolated mediums, but rather, may reflect that each client devices' 120b-d configuration permits communicate with the group owner via Channel 1.

As all of the client devices are communicating on the same channel (Channel 1), it may be difficult or impossible for each to achieve its desired operational behavior. For example, where one of the client devices is engaged in a voice-over-IP (VOIP) operation, the client device may compete for bandwidth with another client device. Devices 120c and 120d may be communicating directly with one another within Channel 1 across the connection 115d. The connection 115d may be, e.g., a TDLS link, or may reflect continual communication between devices 120c and 120d through group owner 120a.

Accordingly, various embodiments transition 105 each of connections 115b-d from Channel 1 to Channel 2, so as to achieve a second configuration 100b. Each of the connections 115b, 115c and 115d may now occur on Channel 2, thereby alleviating congestion on Channel 1.

Channel Reassignment without Group Retention

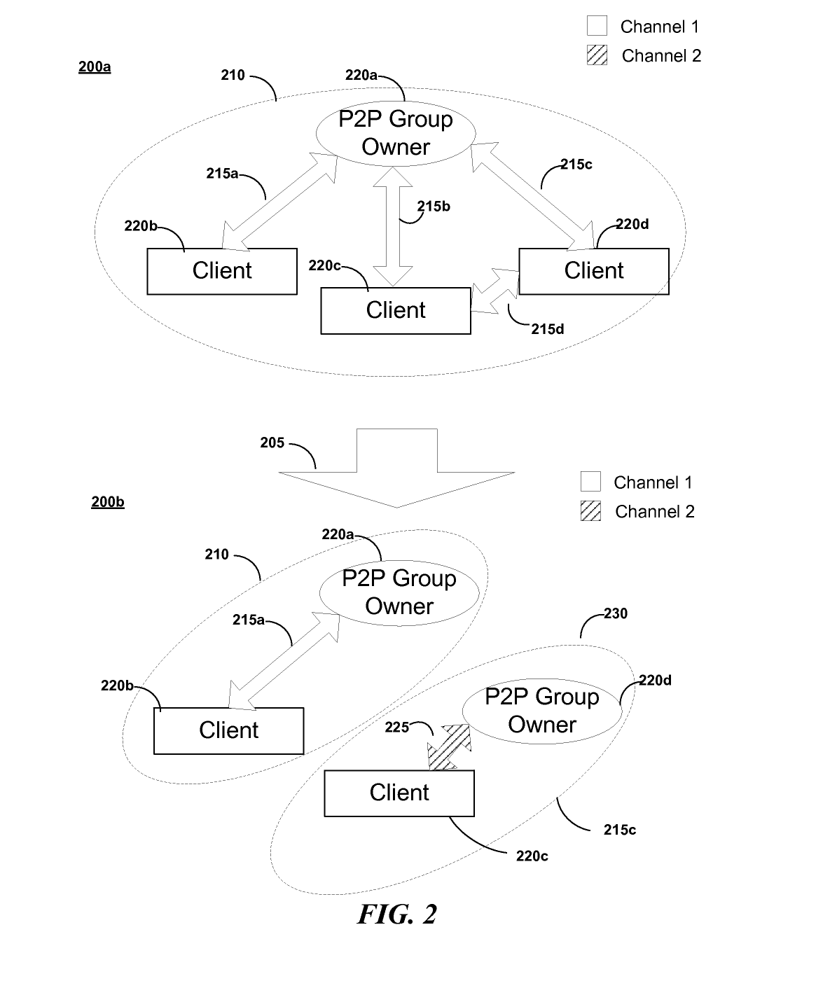

FIG. 2 is a block diagram showing a channel reassignment process as implemented in some embodiments where the reassigned clients enter a new group. As in FIG. 1, in an initial configuration 200a, an initial group 210 may include a group owner 220a and a plurality of client devices 220b-d in communication across connections 215a-d in a first channel (Channel 1). Following reassignment 205 the group owner 220a may have resolved not only to permit clients 220c and 220d to operate separately on Channel 2, but may also have resolved that conditions are better suited to their operating in a distinct group 230, having only a single, direct connection 225 between one another. Accordingly, the new configuration 200b may be assumed by the devices. In some embodiments the new group owner 220d may be selected as the devices having the strongest channel presence (e.g., highest transmitting and/or receiving power). The new group owner 220d may be selected by group owner 220a or by the members of the group 230. In devices supporting Multiple-Input and Multi-Output (MIMO) operation, the suitability of their relative spatial conditions may likewise be taken into consideration.

When deciding which channels to select and whether to form new groups as described in FIGS. 1 and 2, the group owner may consider several factors, including: 1) which client devices are communicating with one another and/or with the group owner, i.e., what is their topology; 2) how strong is the link between the devices (e.g., as determined by measurement requests discussed herein); and 3) do the existing links possess characteristics suitable for the traffic they handle (e.g., reliability). A weighted average of these factors in relation to one or more thresholds may be used to determine whether, and which, channels to transition, as well as whether to form a new group.

### Alternative Channel Selection

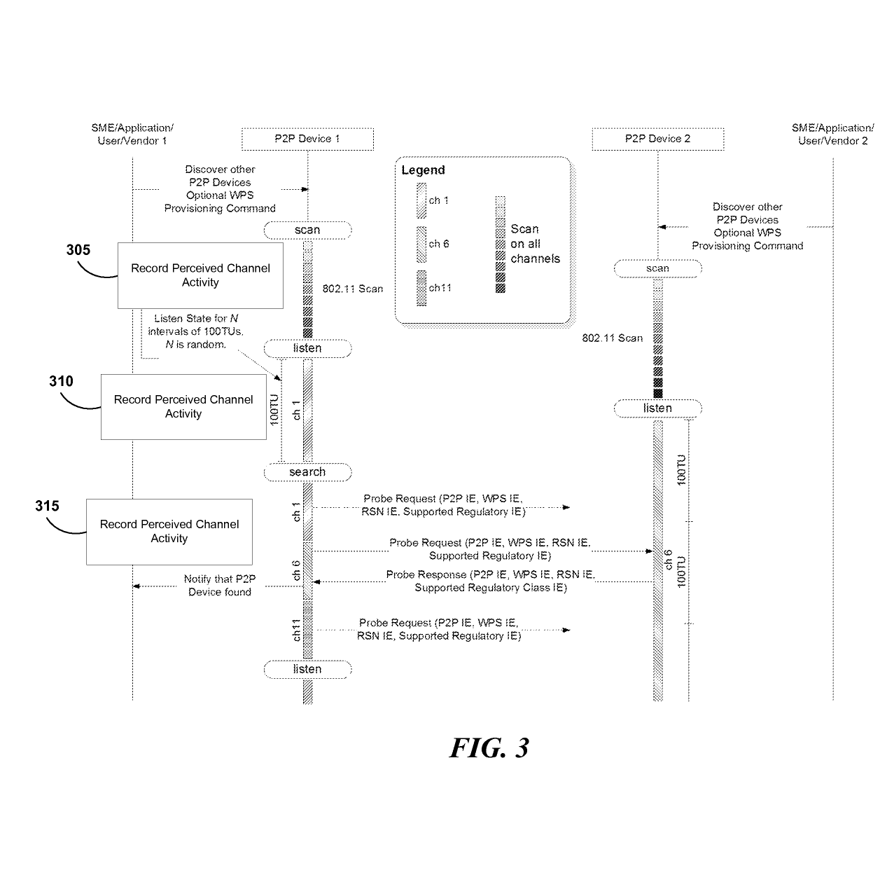

FIG. 3 is a timeline showing steps in the scan and search phases of P2P device discovery as implemented in some embodiments. Although alternative channels may be identified at various points as discussed herein, in some embodiments a device anticipating its role as a group owner may take note of available channels prior to establishing a group. For example, the device may note available and unavailable channels by considering beacons, probe requests, and group information advertisements from other devices in the environment.

In the timeline of FIG. 3, a device may consider available channels at the time 305 during scanning, time 310 during listening, and/or time 315 during searching. For example, during scanning, at time 305, the device may note channels without existing activity (e.g. channels in which no beacon frames or probe response frames are received). These channels may be more highly prioritized for consideration during a subsequent transition event. During listening at time 310, if, e.g., a probe request is received for a group the device will not join, the system may identify any channel information in the probe or subsequent requests to assist with future channel transitions. For example, if a probe request indicates that another group owner may communicate on a different channel, that channel may be excluded, or accorded less priority, among the candidate channels later considered. Pursuant to the P2P standard, power save mechanisms in neighboring devices may be taken in consideration when assessing a particular channel's availability.

### Example Channel Switch Announcement Message Format

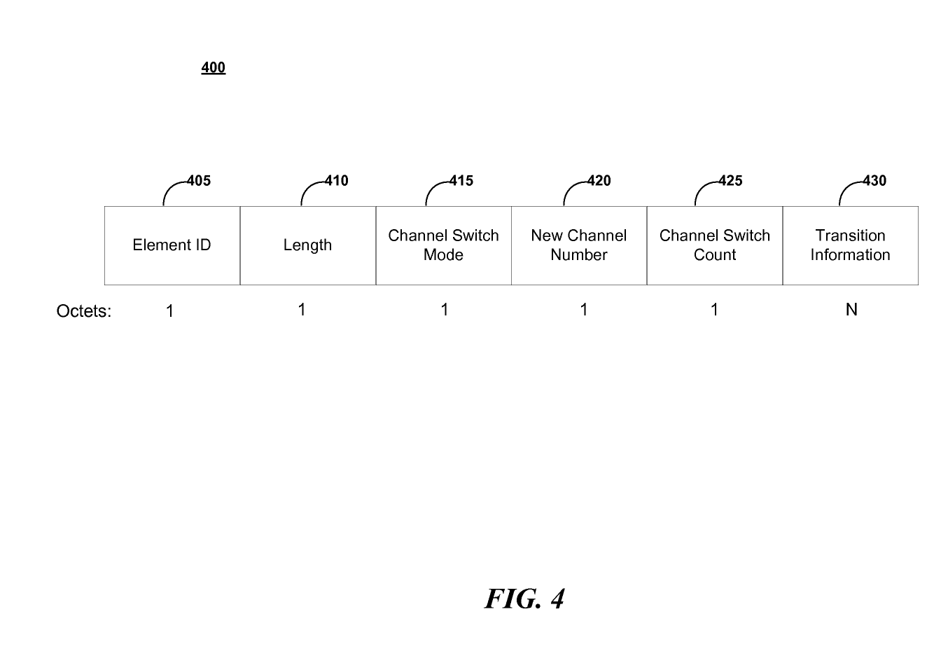

FIG. 4 illustrates a modified channel switch announcement message (e.g., as may appear in the 802.11-2012™ standard) as may occur in some embodiments. In accordance with the existing 802.11™ channel request message format, the element ID 405 may be set to 3 and may serve as an identifier for the channel switch announcement. The length field 410 may be set to 3+N to reflect the additional transitional values 430. The Channel Switch Mode 415 field may indicate any restrictions on transmission until a channel switch pursuant to the 802.11 standard. An AP in a BSS or a STA in an IBSS may set the Channel Switch Mode field 415 to either 0 or 1 on transmission (0, e.g., to transmit until the channel is switched and 1 to cease transmission now). In an MBSS, the Channel Switch Mode Field may be reserved. The New Channel Number 420 field may be set to the number of the channel to which the STA is moving. In some embodiments, depending on the values in additional transitional values 430, field 420 may also be used to reflect the channel to which the recipient is to transition.

Pursuant to the 802.11™ standard, for nonmesh STAs, the Channel Switch Count field 425 may be set either to the number of target beacon transmission times (TBTTs) until the device sending the Channel Switch Announcement element switches to the new channel or is set to 0. Pursuant to the 802.11™ standard, a value of 1 may indicate that the switch occurs immediately before the next TBTT. A value of 0 may indicate that the switch occurs at any time after the frame containing the element is transmitted.

For mesh STAs, pursuant to the 802.11 standard, the Channel Switch Count field may be encoded as an octet with bits 6 to 0 set to the time, in units of 2 TU when the MSB (bit 7) is 0, or in units of 100 TU when the MSB (bit 7) is 1, until the mesh STA sending the Channel Switch Announcement element switches to the new channel. A value of 0 for bits 6 to 0 may indicate that the switch occurs at any time after the frame containing the element is transmitted.

A new field Transition Information field 425 consisting of N bytes, may be used to indicate whether the recipient is to form a new group on the designated channel, and if so, if it is to become the new group owner. For example, N may be 6 and the Transition Information field 425 may simply indicate a target MAC address. The recipient may infer form context how exactly the channel change is to be performed. In some embodiments, at least one device entering a new group will have AP capabilities such that it may serve as a group owner. However, in some embodiments it may suffice for the new group to comprise an IBSS without an explicit group owner. This information may be included in New Transition Information field 425 and may be used to more quickly join the new group owner and its clients. New Transition Information field 425 may also indicate which devices (e.g., which MAC addresses) are to accompany the device upon this transition. In some embodiments, new field 425 may indicate that the recipient, rather than the sender, is to transition to the New Channel Number 420 field.

As in the 802.11™ standard, the Channel Switch Announcement element 400 may be included in Channel Switch Announcement frames, in Beacon frames, in Probe Response frames, etc. However, rather than serving as a general broadcast message, the message may be directed to specific clients. Although the information for transitions is provided in new field 425 in this example, one will recognize that the information may appear elsewhere in the frame in some embodiments.

### Example Process for Channel Reassignment

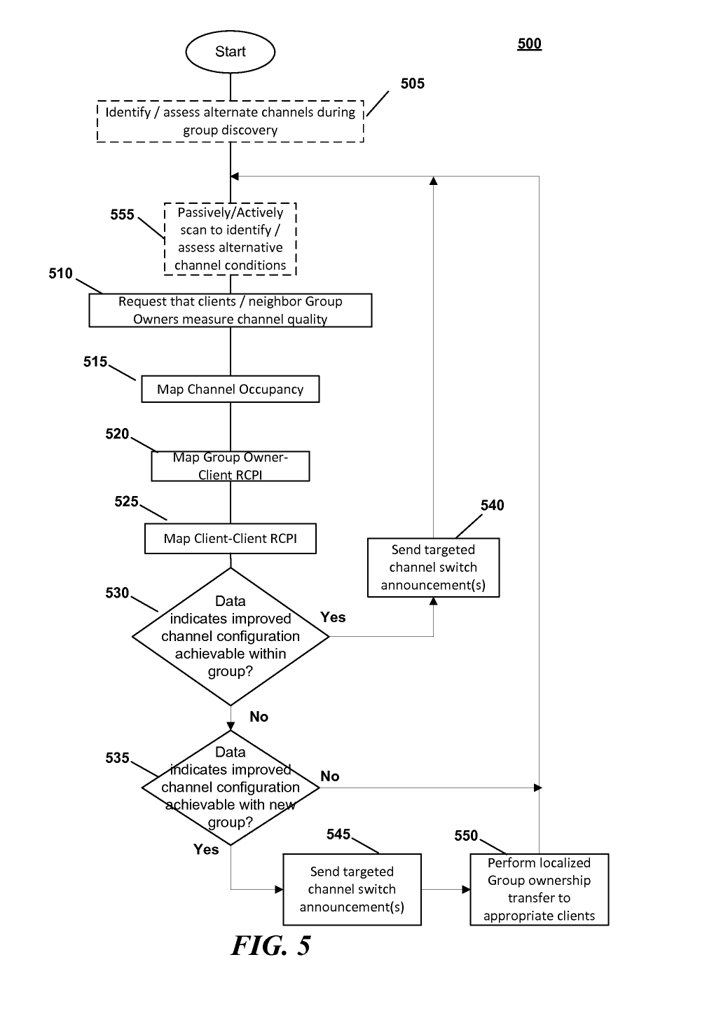

FIG. 5 is a flow diagram showing various operations in a channel reassignment process 500 as may occur in some embodiments. At block 505, the group owner may identify suitable alternative channels (e.g., during device discovery as described herein, via active scanning, or passively after group formation). The group owner may use passive and/or active scanning to periodically measure channel occupancy and/or received channel power indicator (RCPI) on the supported channels. A local record may be made of suitable alternative channels, possibly arranged in a total or partial ordering based on their utility for various purposes. Characteristics of the channels relevant to their subsequent selection to improve communication efficiency may also be recorded. In this manner, different channels suitable for different purposes may be identified. For example, the MIMO characteristics of one channel may make it particularly well suited for handling a bandwidth-intensive peer-to-peer connection, while another channel may be more suitable for shared communication by multiple devices.

At block 510, the group owner may request that one or more client devices measure their channel quality. For example, the group owner may submit a MLME-MREQUEST message to each of the clients (e.g., as specified in the IEEE Standard 802.11-2012™). Requests may be sent not only to assess group owner-client communications, but also to assess client-to-client communications, e.g., across a DLS link. Clients that were previously asked to leave the group, that may now be Group Owners of their own groups, may also be queried to determine which channels they may have chosen to now operate upon. The group owner may use frame requests to ask that each client return RRM capabilities support status, link measurements to other clients, RCPI on supported channels, etc.

At blocks 515-525, the group owner may consider the results of the MLME-MREQUEST requests in conjunction with other factors to determine at block 530 whether a new configuration is desirable. For example, at block 515 the group owner may map channels to clients to assess channel occupancy. Such a mapping may include previous reassignments and notifications concerning reassignments from other Group Owners. At block 520, the group owner may consider, e.g., the RCPI levels returned from the link measurement requests for the group owner to client links. The RCPI, along with other characteristics of the channel may be considered, to determine whether a reassignment is desirable. At block 520, the group owner may map channel occupancy across the channels as well as group owner to client and client to client RCPI measurements. At block 525, the RCPI for client to client links may also be considered. Other factors, such as the number of frames received in an interval, retransmission rates, pass and failure rates, average access delays, etc., may also be considered.

At block 530, the group owner system may determine whether the collected data and channel information indicate that an improved channel configuration may be achieved by reallocating channels between devices in the current group. If one or more configurations have been identified, the system may select the most efficient reconfiguration and at block 540 begin issuing channel transition request messages. A record of the current client-channel map may be updated accordingly.

At block 535, the system may determine whether the collected data and channel information indicates that an improved channel configuration may be achieved by creating a new group operating on one or more new channels. If so, the group owner may issue channel transition request messages at block 545. These transitions may anticipate a subsequent group-ownership handoff to a client operating on the new channel(s) at block 550. The new group owner on the new channel(s) may then perform its own instance of the process 500, exchanging channel status information at block 510 with the original group owner. In this manner, the group owners may complement the information separately received via their own measurement requests. Passive scanning of the alternative channels may continue at block 555, e.g. by monitoring for frames in other channels to determine if neighboring devices have ceased their use of one or more channels.

As mentioned, numerous factors may be considered at blocks 530 and 535 when determining how to reorganize channel assignments. The group owner may group sets of clients into potential offloading targets based on, e.g.: clients with bandwidth-intensive persistent connections; the client's relative RCPI with the group owner; the client's relative RCPI to/from a desired peer; the client's mutual assessment of interference on a candidate offloading channel; the presence of legacy devices (e.g., 802.11b) in common connection that implement bandwidth-intensive connections; etc. The decision to transition clients to a new group at block 535 may be based on additional factors, e.g., the presence of a cellular data connection or the relative RCPI to most of the client peers.

One will recognize that FIG. 5 depicts an example process flow and that the depicted steps need not occur in exactly this manner. For example, determinations 530 and 535 are certainly not mutually exclusive in all embodiments, and the group owner may decide to both switch client channels within its group and direct some clients to form their own group.

### Computer System

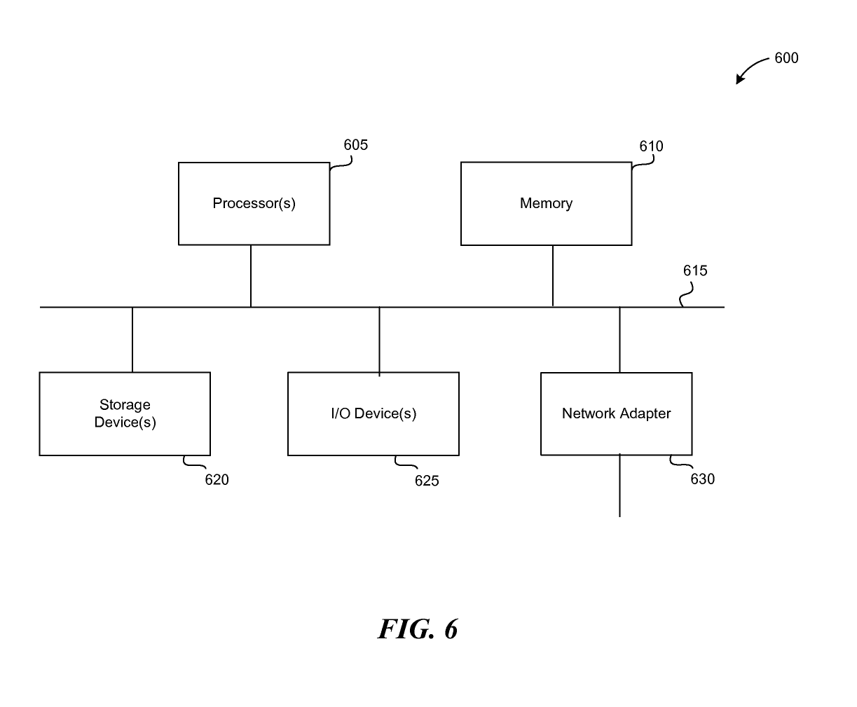

FIG. 6 is a block diagram of a computer system as may be used to implement features of some of the embodiments. The computing system 600 may include one or more central processing units (“processors”) 605, memory 610, input/output devices 625 (e.g., keyboard and pointing devices, display devices), storage devices 620 (e.g., disk drives), and network adapters 630 (e.g., network interfaces) that are connected to an interconnect 615. The interconnect 615 is illustrated as an abstraction that represents any one or more separate physical buses, point to point connections, or both connected by appropriate bridges, adapters, or controllers. The interconnect 615, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 610 and storage devices 620 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non transitory” media) and computer-readable transmission media.

The instructions stored in memory 610 can be implemented as software and/or firmware to program the processor(s) 605 to carry out actions described above. In some embodiments, such software or firmware may be initially provided to the processing system 600 by downloading it from a remote system through the computing system 600 (e.g., via network adapter 630).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A computer-implemented method for mitigating channel congestion in a peer-to-peer (P2P) group, comprising:
identifying at least one alternative channel based upon the traffic of the at least one alternative channel;
receiving, from a first client device in the P2P group, a first quality indication for a first existing communication channel;
determining the bandwidth demands of traffic associated with the first client device;
determining, based upon the bandwidth demands and upon the first quality indication, to reassign the first client device from the first existing communication channel to the at least one alternative channel; and
sending a first channel switch announcement message causing the first client device to switch from the first existing communication channel to the at least one alternative channel.

2. The computer-implemented method of claim 1, wherein the P2P group is based on a protocol defined by a wireless networking point-to-point protocol standard.

3. The computer-implemented method of claim 1, wherein identifying at least one alternative channel comprises listening for probe requests on the alternative channel.

4. The computer-implemented method of claim 1, wherein the first quality indication comprises a received channel power indication value.

5. The computer-implemented method of claim 1, wherein the channel switch announcement message indicates whether the first client device is to join a new group.

6. The computer-implemented method of claim 1, wherein the first client device is in communication with a second client device across the first existing communication channel.

7. The computer-implemented method of claim 6, further comprising:
sending a second channel switch announcement message causing the second client device to switch from the first existing communication channel to the at least one alternative channel.

8. The computer-implemented method of claim 7, wherein the second channel switch announcement message further causes the second client to assume a group owner status in a second P2P group, the second P2P group including the first client device.

9. A non-transitory computer-readable medium comprising instructions configured to cause a computer system, via one or more processors, to perform a method, comprising:
identifying at least one alternative channel based upon the traffic of the at least one alternative channel;
receiving, from a first client device in a P2P group, a first quality indication for a first existing communication channel;
determining the bandwidth demands of traffic associated with the first client device;
determining, based upon the bandwidth demands and upon the first quality indication, to reassign the first client device from the first existing communication channel to the at least one alternative channel; and
sending a first channel switch announcement message causing the first client device to switch from the first existing communication channel to the at least one alternative channel.

10. The non-transitory computer-readable medium of claim 9, wherein identifying at least one alternative channel comprises listening for probe requests on the alternative channel.

11. The non-transitory computer-readable medium of claim 9, wherein the first quality indication comprises a received channel power indication value.

12. The non-transitory computer-readable medium of claim 9, wherein the channel switch announcement message indicates whether the first client device is to join a new group.

13. The non-transitory computer-readable medium of claim 9, wherein the first client device is in communication with a second client device across the first existing communication channel.

14. The non-transitory computer-readable medium of claim 13, the method further comprising:
sending a second channel switch announcement message causing the second client device to switch from the first existing communication channel to the at least one alternative channel.

15. The non-transitory computer-readable medium of claim 14, wherein the second channel switch announcement message further causes the second client to assume a group owner status in a second P2P group, the second P2P group including the first client device.

16. A computer system comprising:
at least one processor;
at least one memory comprising instructions configured to cause the computer system, via one or more processors, to perform a method, comprising:
identifying at least one alternative channel based upon the traffic of the at least one alternative channel;
receiving, from a first client device in a P2P group, a first quality indication for a first existing communication channel;
determining the bandwidth demands of traffic associated with the first client device;
determining, based upon the bandwidth demands and upon the first quality indication, to reassign the first client device from the first existing communication channel to the at least one alternative channel; and
sending a first channel switch announcement message causing the first client device to switch from the first existing communication channel to the at least one alternative channel.

17. The computer system of claim 16, wherein identifying at least one alternative channel comprises listening for probe requests on the alternative channel.

18. The computer system of claim 16, wherein the first quality indication comprises a received channel power indication value.

19. The computer system of claim 16, wherein the channel switch announcement message indicates whether the first client device is to join a new group.

20. The computer system of claim 16, wherein the first client device is in communication with a second client device across the first existing communication channel.

21. The computer system of claim 20, the method further comprising:
sending a second channel switch announcement message causing the second client device to switch from the first existing communication channel to the at least one alternative channel.

22. The computer system of claim 21, wherein the second channel switch announcement message further causes the second client to assume a group owner status in a second P2P group, the second P2P group including the first client device.
